(19) United States
(12) Patent Application Publication
(10) Pub. No.: US 2008/0081129 A1
(43) Pub. Date: Apr. 3, 2008

(54) Method for Treating a Polymer Material, Device for Implementing this Method and Use of this Device for Treating Hollow Bodies

(76) Inventors: Nasser Beldi, Lannion (FR); Patrick Chollet, Lannion (FR); Fabrice Oge, Lannion (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/793,968

(22) PCT Filed: Dec. 23, 2005
(86) PCT No.: PCT/FR05/03277

§ 371 Date: Nov. 6, 2007

(30) Foreign Application Priority Data
Dec. 23, 2004 (FR) 0413862

(51) Int. Cl. H05H 1/24; H05H 1/46

(52) U.S. Cl. 427/575; 427/569

(57) ABSTRACT

A method and device for treating a polymer to coat the surface thereof with a barrier-effect coating. The method comprises a discharge plasma in a tetrafluoroethane-1,1,1,2. or pentafluoroethane gas. The invention also concerns a device for implementing said method for treating hollow bodies. The invention further concerns the use of such a device for treating a rigid or flexible hollow body made of HDPE.

### TECHNICAL FIELD OF THE INVENTION

This invention relates to the technical field of surface treatment methods for objects made of polymer material, these objects being designed for the packaging of gaseous, liquid or solid products, or for the packaging of mixtures of such products.

The invention more specifically relates to techniques for deposit on the surface of polymer materials by means of a precursor gas vapour chemically activated by an electrical discharge under reduced pressure, for the purpose of changing the physicochemical properties of the surface of said object made of polymer material.

The method according to the invention finds an important industrial application and significance in that it makes it possible to reduce the diffusion of gases and liquids through the wall of the polymer object.

The method according to the invention in particular makes it possible to improve the barrier properties of PEHD containers with respect to petrol, White Spirit (distillation cut from petroleum, refined, containing less than 0.05% of benzene), water, n-butyl acetate and oxygen.

The method of the invention in particular finds a major industrial significance in that it makes it possible to increase the hydrocarbon diffusion barrier properties obtained by low pressure plasma deposit on a given polymer material, by electrical discharge under reduced pressure of a fluorinated gas or gaseous composition including at least one fluorinated gas.

### STATE OF THE ART

The use of polymers in the field of packaging and storage of various products, in particular food products and chemical products presents numerous advantages.

In fact, polymer materials are light, flexible, strong, less costly and easier to implement compared to metals or glass.

Unfortunately, their barrier properties with respect to the diffusion of certain liquid or gaseous products, such as oxygen or carbon dioxide, are in general poor compared to those of metals and glass.

This is in particular true for the polymers most used in the packaging industry such as PE (polyethylene), PP (polypropylene) or PET (polyethylene terephthalate).

Moreover, the strength of these polymers is too low for their use to be possible in the packaging of certain solvents and volatile compounds of low molecular weight, of certain acids like acetic acid, or of solutions of surface active agents.

Such products packaged in a container made of polymer material can degrade, on the one hand, the surface of the container in contact with said product and, at the same time, various properties of the polymer material thus leading over time to an irreversible mechanical weakening of said container.

Moreover, on account of diffusion phenomena, these same products can migrate slowly and continuously from the inside of the container made of polymer material to the outside by crossing the wall of said container made of polymer material and in this way spreading into the environment.

During this migration, a more-or-less significant portion of these products is trapped, thus increasing the initial weight of the container made of polymer material.

The variation in weight may be of several percent and, over time, the wall of the container made of polymer material swells and its chemical composition changes.

Its mechanical properties sometimes change dramatically and an irreversible mechanical weakening of said container can be observed.

The deposit of a material as a thin layer, recognized for its barrier properties or its protective properties, on the internal and/or external surface of a container made of polymer material is widely known and has been used for numerous years for solving the various problems posed above.

This operation for the deposit of a material as a thin layer on such polymer material substrates can be carried out, for example, by deposit in the vapour phase under high vacuum (commonly designated as PVD, Physical Vapour Deposition) or by deposit in the plasma phase under rough vacuum (commonly designated as PCVD, Plasma Chemical Vapour Deposition or PECVD, Plasma Enhanced Chemical Vapour Deposition).

More precisely, the techniques of deposit of a material as a thin layer by plasmas consist in using a gas or a gaseous mixture in which the atomic elements forming the molecular structure of said material as a layer are present.

Such gases or gaseous mixtures are said precursors. This (theses) gas(es) is (are) introduced into a reaction chamber in the vapour state at low pressure and then decomposed by an electrical discharge thus forming the plasma.

The plasma vapour thus created frees atoms and molecules that are more-or-less unstable but very reactive which recombine and condense in a thin layer on the surface of the polymer to be coated.

Document U.S. Pat. No. 3,485,666 (from 1965) discloses a method for the creation of a barrier layer based on silicon nitride. Document U.S. Pat. No. 3,442,686 (from 1969) discloses a method for creation of a barrier layer based on silicon oxide. Documents U.S. Pat. No. 4,756,964 (from 1986) and WO99/49991 describe deposits of carbon. Document U.S. Pat. No. 4,830,873 (from 1985) describes the creation of a protective layer against chemical and physical aggressions, the precursor gas used being a mixture of HMDSO (hexamethyldisiloxane) and oxygen.

Deposits of materials in fluorinated thin layers on polymer surfaces make possible improvement of the hydrocarbon diffusion barrier effect of said polymer surface (see document U.S. Pat. No. 4,869,922).

For the creation of a barrier to the diffusion of hydrocarbons for the polymer surface cited above, use of the plasma deposit technique may be very advantageous and constitutes an extremely interesting alternative to the standard fluorination method.

As a matter of fact, said standard fluorination method conventionally consists in exposing the polymer material surface to a fluorinated gas under precise conditions of pressure and temperature for a very long time that may reach several hours.

This fluorination technique, which is a very costly investment, requires the use of great quantities of fluorinated gases which must be reprocessed at the end of the fluorination phase.

Deposit by plasma makes it possible to obtain hydrocarbon diffusion barrier performance characteristics comparable to those obtained by standard fluorination by using, however, very low quantities of precursor gas and run times in general much shorter.

However, the two major disadvantages of the plasma deposit technique are the use of precursor gases that are generally very costly and often complex implementation methods that make of it a technique that is very difficult to industrialise.

The construction of a hydrocarbon diffusion barrier for a polymer surface finds an important application in the field of automobile petrol tanks.

Document DE 3027531 (from 1980) describes a treatment method for such fuel tanks made of high density PE polymer (PEHD or HDPE) by a PECVD plasma technique in which the precursor is a fluorinated gas vapour or a mixture of fluorinated gases introduced at low pressure. Document DE3908418 describes the use of a mixture of the fluorinated precursor CHF₃ and C₄H₆. Document EP 0739655 describes the creation of multi-layers from the precursors C₂H₄, CF₃H.

Industrial implementation of the techniques mentioned above remains tricky and maladapted to technical-economic constraints, in particular on account of the high cost of precursor gases and the high cycle times.

Prior to carrying out deposit of a thin layer with a diffusion barrier effect on a polymer surface, a preparation of said polymer surface is often conducted with, for example, the same low pressure plasma generation technique as that used to carry out said thin layer deposit.

The gases or gaseous mixtures used in this case must change the energetic and sometimes even the chemical state of the polymer surface without, if possible, leading to the growth of a thin layer of an amorphous material.

Among these gases may be mentioned, non-exhaustively, argon, oxygen, carbon dioxide, hydrogen or a combination of these gases.

Document U.S. Pat. No. 4,536,271 (from 1983) describes, for example, the use of an oxygen plasma. Patent EP 0460966 (from 1991) describes the generation of plasma at atmospheric pressure, as a corona treatment, to prepare the surface.

### SUMMARY PRESENTATION OF THE INVENTION

In a first, currently preferred embodiment of this invention, the coating on the polymer material is obtained at low pressure from a gaseous plasma of tetrafluoroethane-1,1,1,2 (C₂H₂F₄, or H₂FC-CF₃), a mixture conventionally designated by the name HFC R134a.

In a second, currently preferred embodiment of this invention, the coating on the polymer material is obtained at low pressure from a gaseous plasma of pentafluoroethane (C₂HF₅ or HF₂C—CF₃), a product conventionally designated under the name HFC R125.

Other objects and advantages of this invention will appear clearly in the detailed description below.

The invention makes it possible, among other things, to obtain a coating with barrier properties to several compounds simultaneously under very advantageous technical-economic conditions.

### DETAILED DESCRIPTION OF THE INVENTION

The inventors have discovered in a very surprising way that the improvement in hydrocarbon diffusion barrier properties obtained by low pressure plasma deposit on a given polymer material could vary in a very broad gain range, capable of going from one to several tens, according to the fluorinated gas or the gaseous composition comprising at least one fluorinated gas brought to the plasma state that was used, and this for operational conditions in other respects identical (flow rate of the gases, pressure, temperature, power of the electrical discharge for the generation of the plasma, technique of generation of the plasma, duration of the application of the plasma).

The inventors are not in a position to give an explanation of this surprising discovery.

The inventors have observed that, in the field explored, there are no obvious correlations between the hydrocarbon diffusion barrier performance characteristics and the ratios between the various quantities of atoms per unit volume of fluorinated gas or of gaseous composition comprising at least one fluorinated gas.

The inventors have also discovered that, in a surprising way, it can be extremely advantageous to create a special initial deposit layer and then to proceed next to the deposit of the fluorinated layer, without being able to explain it clearly.

Preferentially, the authors propose the creation of an initial deposit of hydrogenated amorphous carbon with acetylene gas at low pressure brought to the plasma state, and then the creation of a second deposit of fluorinated carbon by means of a plasma of R134 (C₂H₂F₄, or H₂FC-CF₃ or Tetrafluoroethane-1,1,1,2).

In addition to the excellent performance characteristics of the hydrocarbon diffusion barrier properties obtained, one of the advantages of such a method is that the reactive fluids used are inert, not dangerous and inexpensive, which makes the invention very advantageous from an economic point of view.

The inventors have, moreover, been able to verify that the creation of the second fluorinated layer from R134 gas is particularly interesting, because the hydrogen and/or the hydrogenated molecules liberated by this precursor made it possible, by their incorporation in said second fluorinated layer, to very appreciably improve the stability of the layer.

They attribute this behaviour to saturation phenomena of the pending bonds which make it possible to reduce the mechanical constraints on the interfaces.

This distinctive feature was not observed when the second fluorinated layer was created from other fluorocarbon gases such as C₂F₆, C₆F₆ or C₄F₈ which generally require addition of hydrogen or from other fluorinated gases that are nevertheless a priori similar to R134 gas.

From the operational point of view, the polymer surface for which it is desired to improve the hydrocarbon diffusion barrier properties is introduced into a sealed treatment chamber under vacuum.

Emptying of the air initially contained in said treatment chamber is carried out by means of conventional pumping means, to a vacuum level between 0.001 mbar and 1 mbar, preferentially below 0.1 mbar.

Next, a flow of gas or gaseous mixture is introduced into said treatment chamber.

This generally has the effect of increasing the pressure inside the treatment chamber to values between 0.002 mbar and 10 mbar, the flow rate preferably being chosen to attain a pressure below 1 mbar but above 0.01 mbar.

The gas or gaseous mixture is released in proximity to the polymer surface which has been introduced into the treatment chamber that will be called the treatment zone.

In this treatment zone, electrical or electromagnetic energy is applied by means of specific generation and transport means for said energy, which generally has the effect of bringing the gas or gaseous mixture to the plasma state if certain conditions of pressure and power density of the energy are met.

The entire set of reactions described above and which occur in the entire volume delimited by the presence of the plasma also occurs in immediate proximity to the polymer.

They depend on a certain number of parameters of the method such as the pressure or the nature of the energy used to create the plasma, for example, but also and principally on the gas or gaseous mixture used.

The energies used for the creation of said plasma may be derived from a direct current voltage (DC), from a high frequency (HF), from a radiofrequency (13.46 MHz and its harmonics for example) or from microwaves (915 MHz, 2,450 MHz).

The space densities of power that are implemented are between 0.01 W/cm³ and 10 W/cm³, but preferentially between 0.1 W/cm³ and 3 W/cm³.

The frequencies preferentially used are those, industrial, of 40 kHz, 13.56 MHz and 2,450 MHz.

The plasma state then has the effect of bringing said gas or gaseous mixture to a state of partial ionization.

The particles derived from these excitation and decomposition mechanisms may then either recombine among themselves to result in more-or-less unstable particles which may then condense on the polymer surface which is immersed in this plasma mixture, or likewise condense on the polymer surface.

For the deposit method, the creation of a deposit layer whose thickness depends on the time of application of the plasma phase is then observed.

Therefore, after a sufficient plasma phase time which may be between one second and a few minutes but preferentially at least one second and at most thirty seconds, the energy application is stopped which stops all plasma generation.

The flow of the gas or gaseous mixture is also stopped, and then the chamber is brought back to atmospheric pressure.

In a variant, before bringing the chamber back to atmospheric pressure, a second deposit cycle is carried out by reproduction according to the cycle described previously from a new gas or gaseous mixture.

In another variant, several cycles are carried out with different gases or gaseous mixtures thus making it possible to coat the polymer surface with as many layers.

In another variant, the first cycle may be a step for preparation of the polymer surface which consists in “chemically cleaning” said polymer surface.

In this last variant, a preparation of the polymer surface is conducted by using, preferentially, a plasma of argon or argon+hydrogen mixture.

The inventors have also observed that it can be advantageous to use a plasma of carbon dioxide in order to increase the number of oxidised sites on the polymer surface favourable in particular for the obtaining of better performance characteristics for the oxygen barrier deposits, for example.

The pressure conditions are then between 0.01 mbar and 5 mbar, but preferentially between 0.05 mbar and 1 mbar.

The power conditions are those described above and the plasma preparation times are generally between 1 second and 30 seconds according to the nature of the polymer surface to be prepared.

After this preparation phase, deposit of the barrier layer or the different sub-layers constituting the barrier layer is conducted.

In this way this barrier layer may be made up of a single layer or the superposition of two or more layers of different chemical nature.

Preferentially, and according to a preferred variant, the inventors created two types of sub-layers: a first sub-layer of hydrogenated amorphous carbon and a second sub-layer of fluorinated amorphous carbon.

The first sub-layer of hydrogenated amorphous carbon is created from acetylene gas whose beneficial distinctive characteristic is a more-or-less significant fall in the pressure when this gas is put in a plasma state thereby promoting the obtaining of a more homogenous deposit.

The second sub-layer of fluorinated amorphous carbon is created from the precursor gas R134 with chemical formula C₂F₄H₂ or from precursor gas R125 with chemical formula C₂F₅H according to the application.

R125 is used in certain cases, because it makes possible better stability and chemical resistance in particular to products with a significant surface-active effect.

Results

Results 1

Rigid containers made of High Density Polyethylene (PEHD) polymer, hollow and totally open, with a 0.2 litre capacity were treated according to the method of the invention.

By “rigid” is meant a container whose wall has a thickness of at least one mm as is the case in this example.

Such a container is placed in a metallic treatment chamber of cylindrical shape connected to a microwave emission device emitting at 2,450 MHz with standard waveguide means with standard dimensions.

In practice, the device makes it possible to create a differential pressure between the internal volume of the container and the external volume in such a way that the outside pressure is greater than the internal pressure.

In this way, if the external pressure is sufficiently great, the plasma generation occurs solely inside the container and the deposit is then created on the internal wall of the latter.

In accordance with this invention, the treatment of the container occurs in several steps.

The pumping circuit is connected up with the treatment chamber and with the internal volume of the polymer container.

A vacuum is created by means of a standard primary vacuum pump.

The pressure inside the container is brought back to a pressure less than 0.05 mbar while the pressure on the outside is maintained at approximately 30 mbar.

A flow of a mixture of argon and hydrogen gases is introduced into the container in the proportions of 90/10 although this is not a requirement in order for the internal pressure to attain a value between 0.05 and 1 mbar.

Microwave energy is then applied at a power of approximately 200 W, which makes possible the creation of a surface preparation plasma maintained for a duration of 6 seconds. After this time, the microwave energy and the gas mixture flow are cut off.

An acetylene gas flow is introduced into the container in such a way that the internal pressure attains a value between 0.05 and 0.3 mbar.

Microwave energy is then applied at a power of approximately 300 W, which makes possible the creation of a deposit plasma maintained for a duration of one second.

After this time, the microwave energy and the gas flow are cut off.

An R134 gas flow is introduced into the container in such a way that the internal pressure attains a value between 0.05 and 0.3 mbar.

Microwave energy is then applied at a power of approximately 300 W, which makes possible the creation of a deposit plasma maintained for a duration of six seconds.

After this time, the microwave energy and gas flow are cut off.

The pumping circuit is isolated from the treatment chamber and from the internal volume of the polymer container.

The treatment chamber and the polymer container are brought back to atmospheric pressure.

A packaging and measurement protocol was followed which is described in the standards relating to the transport of dangerous materials.

The containers are filled with a liquid load of approximately 100 grams, and then their openings are closed by means of a heat-sealing aluminium film.

Thus packaged, the containers are placed under study at 40° C. for a certain time. The permeability is measured by weighing at regular intervals of at least 1 day over a period that may stretch over several months.

Product losses by diffusion through the container wall are then expressed in mg/day.

The measurement of permeability to oxygen is done with an OXTRAN apparatus (MOCON) over a period of at least 24 hours. The permeability is expressed in this case in cm³/day.

Standard product diffusion barrier performance characteristics have been measured and are summarized in Table 1.

Product loss values are given after a period of packaging (in days) indicated in parentheses.

TABLE 1
Diffusion barriers performance characteristics.

| | | Petrol | n-butyl | | White |
|---|---|---|---|---|---|
| | O₂ | F | acetate | Water | Spirit |
| | (24 h) | (40) | (40) | (40) | (40) |
| Untreated | 0.27 | 374 | 96 | 2.3 | 250 |
| Treated | 0.05 | 13 | 20 | 0.5 | 15 |
| Gain | 5 | 28 | 5 | 4 | 17 |

The containers thus treated have shown a very good barrier to several compounds such as petrol, White spirit, water, n-butyl acetate and oxygen.

During the process of diffusion of the product contained through a polymer wall, a more-or-less large portion of said product is trapped in the polymer mass, thus expressing itself as a weight gain.

Application of the inventive method as described above, to these polymer containers, also gives an improvement in their resistance to weight gain after 40 days of packaging.

| | White | n-butyl | Acetic | Nitric |
|---|---|---|---|---|
| | spirit | acetate | acid | Acid |
| Untreated | 3.85% | 1.87% | 0.44% | 0.31% |
| Treated | 2.64% | 0.95% | 0.25% | 0.11% |
| Gain | 1.46 | 1.97 | 1.76 | 2.82 |

In the same way, an improvement in the resistance to abrasion is observed.

These results were confirmed by an expert report carried out by the TNO (Netherlands Organisation for Applied Scientific Research).

Results 2

Hollow, flexible High Density Polyethylene (PEHD) polymer containers, with a capacity of 0.5 litres, were treated according to the method of the invention.

By “flexible” is meant a container whose wall has a thickness less than 1 mm as is the case in this example for which the thickness is 0.5 mm.

Such a container is placed in a metallic treatment chamber of cylindrical shape connected to a microwave emission device emitting at 2,450 MHz with standard waveguide means with standard dimensions.

These containers are treated in a way similar to the procedure described in Results 1 above.

The power is adjusted in each phase in relation to the surface to be treated.

Containers thus treated have shown a very good barrier to several compounds such as petrol, White Spirit, water, n-butyl acetate, oxygen and standard hydrocarbons.

For example, such containers when untreated show a hydrocarbon diffusion barrier power of 3,000 mg/day, whereas these same containers when treated have a hydrocarbon diffusion barrier power of 25 mg/day at 40° C.

Results 3

Hollow, rigid High Density Polyethylene (PEHD) polymer containers, totally open, with a capacity of 5 litre, were treated according to the method of the invention.

Such a container is placed in a metallic treatment chamber of cylindrical shape connected to a microwave emission device emitting at 2,450 MHz with standard waveguide means with standard dimensions.

These containers are treated in a manner similar to the procedure described in Results 1 above.

The power is adjusted in each phase in relation to the surface to be treated.

Containers thus treated have shown a very good barrier to several compounds such as petrol, White Spirit, water, n-butyl acetate, oxygen and standard hydrocarbons.

For example, such containers when untreated show a barrier power to the diffusion of white spirit of 1,400 mg/day, whereas these same containers when treated have a barrier power to the diffusion of white spirit of 15 mg/day at 40° C. and after 2 months of maceration.

1.-15. (canceled)

16. A method for depositing a coating with a barrier effect on at least one surface of an article made of polymer material, wherein the method comprises:
depositing a first deposit layer with a discharge plasma in acetylene gas at low pressure; and
depositing a second deposit layer with a discharge plasma in at least one of tetrafluoroethane-1,1,1,2 or pentafluoroethane precursor gas,
wherein deposition of the first deposit layer and second deposit layer comprises:
introducing the article made of polymer material into a treatment chamber;
introducing at least one precursor gas into the treatment chamber;
applying one of electrical energy or electromagnetic energy of a sufficient space density power and a sufficient frequency to bring the at least one gas to a plasma state; and
subjecting the article made of polymer material to the plasma state for a sufficient plasma phase time so as to deposit one of the first deposit layer or second deposit layer.

17. The method according to claim 16, further comprising applying the electrical or electromagnetic energy such that the space density of power is in a range from about 0.01 W/cm³ to about 10 W/cm³.

18. The method according to claim 17, further comprising applying the electrical or electromagnetic energy such that the space density of power are in a range from about 0.1 W/cm³ to about 3 W/cm³.

19. The method according to claim 16, further comprising selecting the frequency from the group consisting of 40 kHz, 13.56 MHz, and 2,450 MHz.

20. The method according to claim 16, further comprising maintaining the plasma phase for a time in a range from about 1 second to about 2 minutes.

21. The method according to claim 20, further comprising maintaining the plasma phase for a time in a range from about 1 second to about 30 seconds.

22. The method according to claim 16, further comprising introducing the at least one precursor gas into the treatment chamber at a flow rate such that a pressure inside the treatment chamber is in a range from about 0.002 mbar to about 10 mbar.

23. The method according to claim 22, further comprising introducing the at least one precursor gas into the treatment chamber at a flow rate such that a pressure inside the treatment chamber is in a range from about 0.01 mbar to about 1 mbar.

24. The method according to claim 16, further comprising a preparation step comprising:
preparing at least one surface of the article made of polymer material prior to depositing the first and second deposit layers, the method of preparing comprising:
implementing a low pressure discharge plasma in at least one gas selected from the group consisting of oxygen, hydrogen, argon, carbon dioxide, helium, nitrogen, and combinations thereof by:
introducing the at least one gas into the treatment chamber;
applying one of electrical energy or electromagnetic energy of a sufficient space density power and a sufficient frequency to bring the at least one gas to a plasma state; and
subjecting the article made of polymer material to the plasma state for a sufficient plasma phase time to prepare the at least one surface.

25. The method of claim 24, further comprising implementing a low pressure discharge plasma from a mixture of argon and hydrogen, with a pressure in a range from about 0.01 mbar to about 5 mbar.

26. The method of claim 25, further comprising implementing the low pressure discharge plasma from the mixture of argon and hydrogen with a pressure in a range from about 0.05 mbar to about 1 mbar.

27. The method according to claim 24, further comprising applying the electrical or electromagnetic energy such that the space density of power for surface preparation is in a range from about 0.01 W/cm³ to about 10 W/cm³.

28. The method according to claim 27, further comprising applying the electrical or electromagnetic energy such that the space density of power for surface preparation is in a range from about 0.1 W/cm³ to about 3 W/cm³.

29. The method according to claim 24, further comprising maintaining the plasma phase for a time in a range from about one second to about thirty seconds.

30. The method according to claim 16, further comprising:
depositing a third deposit layer with a low pressure discharge plasma in acetylene or pentafluoroethane gas.

31. The method according to claim 16, further comprising providing the article made of polymer material selected from the group consisting of a polyethylene, a polypropylene, a polyamide, a PET, a vinyl polychloride, and combinations thereof.

32. The method according to claim 16, further comprising providing the article made of polymer material in the form of a substantially open hollow container.

33. The method according to claim 24, wherein the article made of polymer material comprises a substantially open hollow container of high density polyethylene and wherein the internal pressure within the container is less than about 0.05 mbar and the external pressure is about 30 mbar, and wherein the precursor comprises a mixture of argon and hydrogen gases, the method further comprising:
introducing the mixture of argon and hydrogen gas within the treatment chamber at a flow rate such that the internal pressure is in a range of about 0.05 and 1 mbar;
applying microwave energy with a power of about 200 W to form a plasma;
subjecting the article to the plasma for a duration of about 6 seconds; and
turning off the microwave energy and the flow of the mixture of argon and hydrogen gas.

34. The method according to claim 33, wherein depositing a first deposit layer with a discharge plasma in acetylene gas at low pressure comprises:
introducing the acetylene gas to the treatment chamber at a flow rate such that the internal pressure is in a range of about 0.05 and 0.3 mbar;
applying microwave energy with a power of about 300 W to form a plasma;
subjecting the article to the plasma for a duration of about 1 second; and
turning off the microwave energy and the flow of the acetylene gas.

35. The method according to claim 34, wherein depositing a second deposit layer with a discharge plasma in at least one of tetrafluoroethane-1,1,1,2 or pentafluoroethane precursor gas comprises:
introducing the acetylene gas to the treatment chamber at a flow rate such that the internal pressure is in a range of about 0.05 and 0.3 mbar;
applying microwave energy with a power of about 300 W to form a plasma;
subjecting the article to the plasma for a duration of about 6 seconds; and
turning off the microwave energy and the flow of the precursor gas.
